(19) United States
(12) Patent Application Publication
(10) Pub. No.: US 2018/0125134 A1
(43) Pub. Date: May 10, 2018

(54) APPAREL GRAPHIC-CHANGING SYSTEM

(71) Applicant: Richard G. Price, San Diego, CA (US)

(72) Inventor: Richard G. Price, Vista, CA (US)

(21) Appl. No.: 15/808,787

(22) Filed: Nov. 9, 2017

Related U.S. Application Data
(60) Provisional application No. 62/420,142, filed on Nov. 10, 2016.

(51) Int. Cl. A41D 27/08; A41F 1/00; A41B 1/08; G09F 21/02; G09F 7/22

(52) U.S. Cl. CPC A41D 27/08; A41F 1/002; A41B 1/08; G09F 2007/1852; G09F 7/22; G09F 2021/023; G09F 21/02

(57) ABSTRACT

Described here is an article of apparel that includes a base fabric bearing one or more graphical designs; a hinged fabric section having a hinged edge attached to the base fabric and an opposing edge free to pivot about the hinged edge; and magnetic fasteners affixed to both the base fabric and the hinged fabric section and positioned to secure the opposing edge of the hinged fabric section to the base fabric in each of at least two orientations, where at least one of the orientations causes the hinged fabric section to hide at least a portion of the graphical design on the base fabric.

### CROSS-REFERENCE TO RELATED APPLICATION

This application claims priority from U.S. Provisional Application 62/420,142, entitled “Apparel Graphic Changing System” and filed on Nov. 10, 2016.

### FIELD OF DISCLOSURE

This disclosure relates to the display of graphics and messages on apparel and, in particular, to a system and technique for allowing a wearer of the apparel to display multiple graphics or messages on a single item of apparel.

### BACKGROUND

Articles of clothing with the ability to display changeable graphics and designs at the user's discretion are not uncommon. Typically, articles allowing the user to choose between multiple designs comprise bulky, uncomfortable, and visually unbecoming means, such as buttons or hook-and-loop fastener material, for attaching the design to the article of clothing. These means of attaching different designs can become damaged or heavily worn in appearance through repeated washing and wearing of the clothing, causing the changeable graphics to become less aesthetically pleasing and fashionable and causing the fastening mechanisms to become (a) increasingly uncomfortable to the wearer and (b) less effective in their utility or completely ineffective altogether, less able and eventually unable entirely to function for the purpose of holding the selected design in place.

Such means of allowing the user to change between different designs on an article of clothing are commonly fabricated of fibrous or stiff materials made of nylon, polyester, plastic, etc. Such material is often in the form of hook-and-loop fastener material, which, in the world of fashion, is very bulky and considered by many to be unattractive and ill-suited for use on clothing. To release a graphic design attached by hook-and-loop fastener to the article of clothing, the user must pull forcefully on part of the design until the hook-and-loop fastener releases. After changing designs many times and over the course of repeated use, the hook-and-loop fastener can become less effective and eventually cease to function properly. Further, because this means of fastening different designs on an article is made of material which is typically not able to withstand high temperatures or hold up to the intensity of multiple clothes-washing cycles, if the article is washed at certain temperatures or washed often, the hook-and-loop fastener is prone to damage that renders it less effective over time and eventually ineffective entirely.

Sewn buttons are another typical means of fastening designs to an article of clothing. Buttons tend to be very bulky and unattractive in the eyes of many, and buttons require more intricate manual manipulation that does not allow for quick changes between different designs. Further, because of how buttons typically function, the thread holding the buttons onto the article or clothing are prone to damage, breaking, or falling away from the clothing after multiple uses.

### SUMMARY

Described here is an article of apparel that includes a base fabric bearing one or more graphical designs; a hinged fabric section having a hinged edge attached to the base fabric and an opposing edge free to pivot about the hinged edge; and magnetic fasteners affixed to both the base fabric and the hinged fabric section and positioned to secure the opposing edge of the hinged fabric section to the base fabric in each of at least two orientations, where at least one of the orientations causes the hinged fabric section to hide at least a portion of the graphical design on the base fabric.

In some embodiments, at least two magnetic fasteners are positioned near the opposing edge of the hinged fabric section; at least two magnetic fasteners are positioned on the base fabric in a manner to couple with the magnetic fasteners of the hinged fabric section when the hinged fabric section is placed at one orientation; and at least two more magnetic fasteners are positioned on the base fabric in a manner to couple with the magnetic fasteners of the hinged fabric section when the hinged fabric section is placed at another orientation. In certain embodiments, at least one of the magnetic fasteners includes a magnet comprising neodymium or some other ferromagnetic material of sufficient magnetic strength to allow the use of fasteners of very small size, e.g., on the order of ¾ inch in diameter or width and 1/64 inch in thickness.

In some embodiments, the hinged fabric section includes (a) a single piece of fabric folded into halves and attached to the base fabric along the fold and (b) one or more pieces of interfacing material positioned between the halves to fuse them together. In some of these embodiments, one or more of the magnetic fasteners are positioned between the interfacing material and one of the halves of fabric, thereby embedding the fasteners within the hinged fabric section.

In certain embodiments, the hinged fabric section also bears a graphical design, and at least one of the orientations causes the hinged fabric section to expose at least a portion of its graphic design. In certain embodiments, securing the hinged fabric section in one of the orientations causes it to operate in conjunction with the base fabric to display a unified graphic design, and securing it in another of the orientations causes it to operate in conjunction with the base fabric to display an alternative unified graphic design. In many embodiments the base fabric comprises an article of clothing, such as a shirt or a jacket.

Also described here is an item of apparel that includes (a) an article of clothing bearing at least two graphic design elements, (b) a flap of fabric affixed to the article of clothing along one edge of the flap of fabric, creating a hinge that separates the two or more graphic design elements on the article of apparel, and (c) magnetic fasteners affixed to the flap of fabric and the article of clothing and positioned to fasten the flap of fabric to the article of clothing in each of two orientations, where the flap of fabric is positioned such that, when fastened in each of the orientations, the flap of fabric hides at least one of the graphic designs on the article of clothing.

### BRIEF DESCRIPTION OF THE DRAWINGS

FIG. 1 illustrates a front view of an exemplary embodiment of an apparel graphic-changing system wherein a sectional piece of fabric affixed to an item of apparel is positioned to display a first design on the item of apparel.

FIG. 2 illustrates a front view of the apparel graphic-changing system wherein the sectional piece of fabric affixed to the item of apparel is positioned to display a second design.

FIG. 3 illustrates a perspective view of an exemplary embodiment of an apparel-graphic changing system showing a sectional piece of fabric that allows transition between the first and second designs.

FIG. 4 illustrates a side view of an exemplary embodiment of an apparel graphic-changing system and a mechanism for securing a sectional piece of fabric to a base fabric in a manner that is both comfortable and not readily visible to the wearer and that retains its fastening utility, its comfort, and the overall fashionable appearance of the item of apparel over time.

FIG. 5 illustrates another exemplary embodiment of an apparel graphic-changing system to be affixed to an item of apparel.

### DETAILED DESCRIPTION

The following detailed description is merely exemplary in nature and does not limit the disclosure or the application and uses of the invention. As used herein, the word “exemplary” means “serving as an example, instance, or illustration.” Thus, any embodiment described herein as “exemplary” is not necessarily to be construed as preferred or advantageous over other embodiments. Furthermore, there is no intention to be bound by any expressed or implied theory presented in the preceding technical field, background, brief summary, or the following detailed description.

Described here are multiple embodiments of a graphic-changing system for an item of apparel, such as an article of clothing like a shirt or jacket or a fashion accessory like a handbag or backpack, that uses a hinged pieced of fabric to allow transition among multiple possible graphic designs, such as images or textual messages, on the apparel item. The graphic-changing system employs a unique and highly effective mechanism for securing the hinged piece of fabric in place tightly, comfortably, durably, and fashionably against the base fabric with which it cooperates to display the alternative graphic designs.

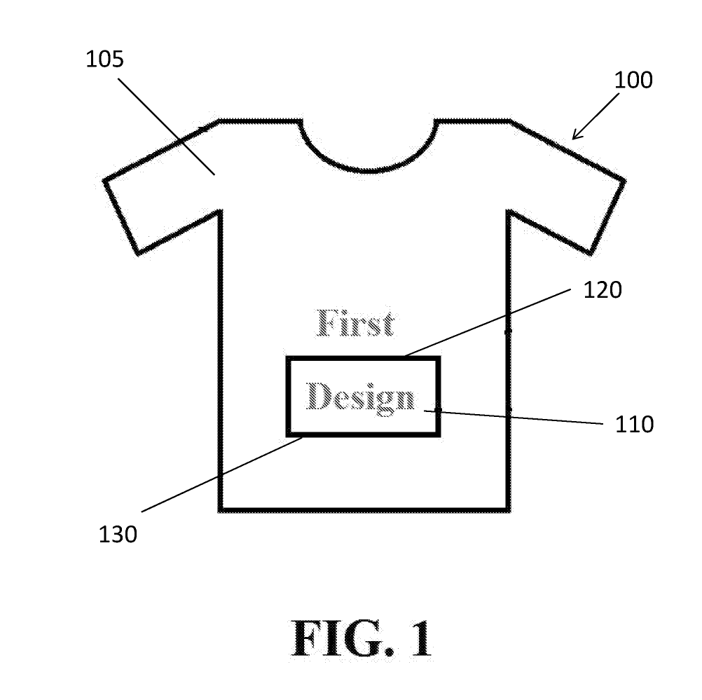

FIG. 1 shows an apparel graphic-changing system 100 for use on or as an item of apparel, such as an item of clothing or a fashion accessory. In the specific embodiment shown here, the apparel graphic-changing system 100 includes a base fabric 105, which in this example takes the form of an article of clothing (specifically a shirt), onto which is mounted a hinged fabric section 110 that allows the wearer of the clothing to alternate among multiple designs (such as images or textual messages) on the face of the clothing. The hinged fabric section 110 is mounted to the base fabric 105 along a hinged connection 120, such as a stitched seam that is not readily visible to the wearer or any other person viewing the item of apparel. The hinged connection 120 anchors one end of the hinged fabric section 110 to the base fabric 105, leaving the hinged fabric section 110 free to pivot about the hinged connection 120 and act as a “flap,” with an opposing, distal end (the “free” end 130) of the hinged fabric section 110 free to move about as desired by the wearer and attach to the base fabric 105 in multiple locations.

In FIG. 1 the hinged fabric section 110 is shown in a “down” position, with its free end 130 resting below the hinged connection 120, and works in conjunction with the base fabric 105 to display a first design. In this particular embodiment, the “FIRST” portion of the first design is printed (or otherwise displayed) on the base fabric 105, and the “DESIGN” portion is printed (or otherwise displayed) on the exposed surface of the hinged fabric section 110.

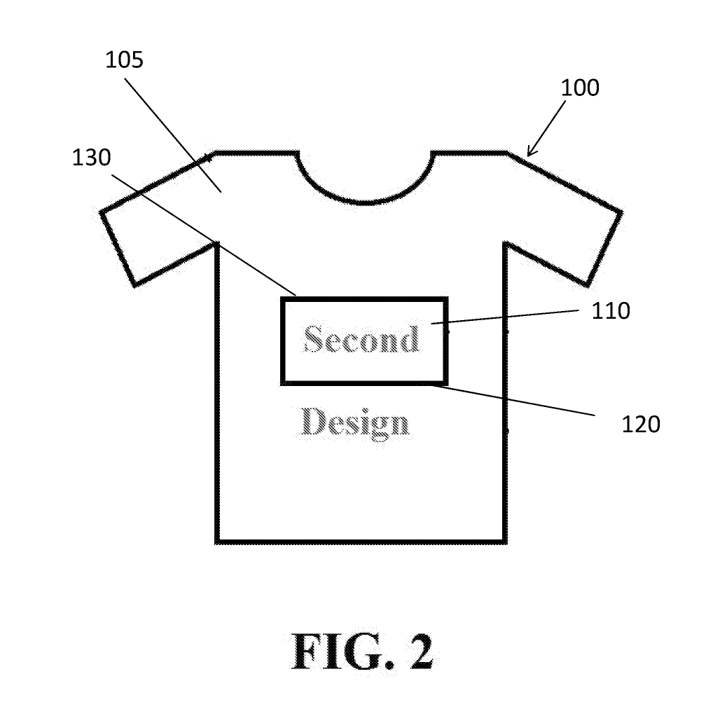

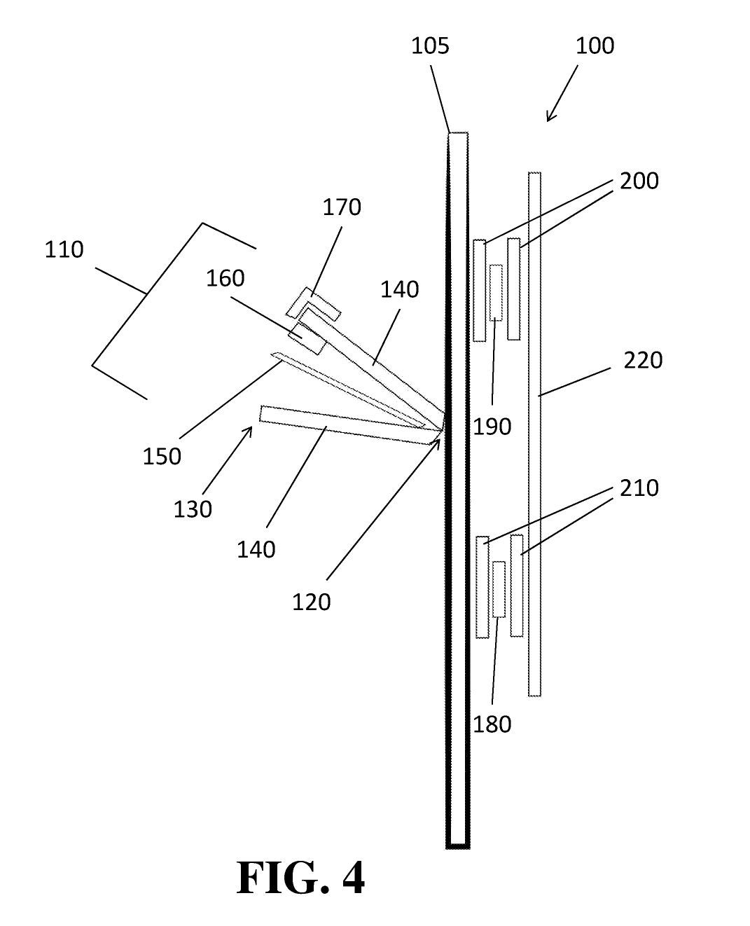

FIG. 2 shows the apparel graphic-changing system 100 of FIG. 1 with the hinged fabric section 110 in an “up” position, with its free end 130 positioned above the hinged connection 120, working in conjunction with the base fabric 105 to display a second design. In this particular embodiment, the “SECOND” portion of the second design is printed (or otherwise displayed) on the exposed surface of the hinged fabric section 110, and the “DESIGN” portion is printed (or otherwise displayed) on the base fabric 105. Note that, when the hinged fabric section 110 is positioned as shown in FIG. 2, it covers and hides the “FIRST” portion of the first design printed on the base fabric 105. Likewise, when the hinged fabric section 110 is positioned as shown in FIG. 1, it covers and hides the “DESIGN” portion of the second design printed on the base fabric 105. One technique for securing the free end 130 of the hinged fabric section 110 to the base fabric 105 is described below with reference to FIG. 4.

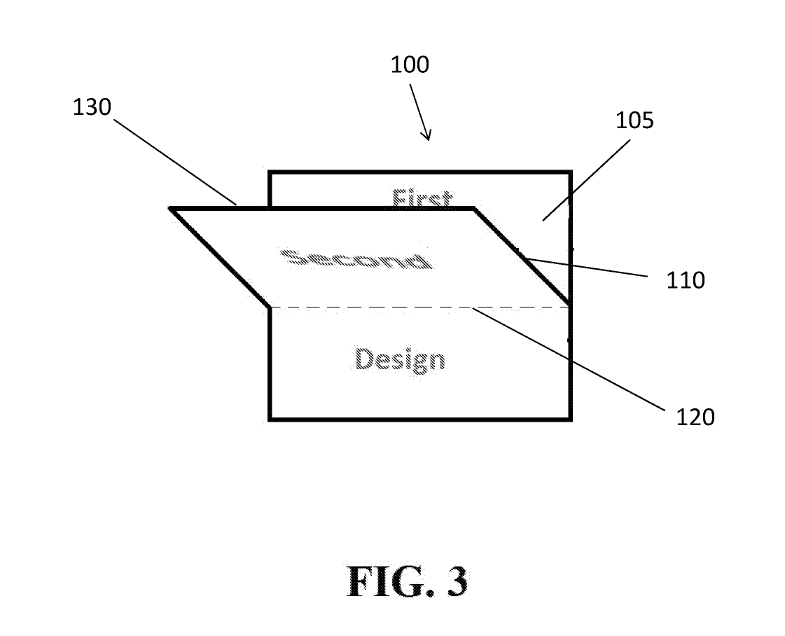

FIG. 3 provides a perspective view of the apparel graphic-changing system 100, showing movement of the hinged fabric section 110 about the hinged connection 120, alternatively exposing and hiding portions of both the base fabric 105 and the hinged fabric section 110 to allow a changing display of the alternative graphic designs at the whim of the wearer.

FIG. 4 shows one technique for fabricating the apparel graphic-changing system 100 to allow for secure, durable, comfortable, and visually-appealing attachment of the free end 130 of the hinged fabric section 110 to the base fabric 105. In the specific embodiment shown here, the hinged fabric section 110 includes a single piece of fabric 140 folded in half, with the fold serving as the location for the hinged connection 120 that attaches the hinged fabric section 110 to the base fabric 105. A bonding interface material 150, such as a piece of fusible-web fabric (e.g., that sold under the Pellon Wonder Under brand), positioned between the two halves of folded piece of fabric 140 is used to fuse the two halves together to give the hinged fabric section 110 a flap-like structure. One or more pieces of ferromagnetic material, such as ferromagnetic strip(s), bead(s), or disk(s) 160, are embedded within the hinged fabric section 110 by placing the disks 160 at desired locations along the free end 130 of the folded piece of fabric 140 and between the folded piece of fabric 140 and the bonding interface material 150, so that the disks 160 are permanently captured and held in place upon fusing the two halves of the folded piece of fabric 140 together. In some embodiments, a strip of trim fabric 170 is also added along the free end 130 of the hinged fabric section 110 (e.g., by sewing or fusing the trim fabric around the free end 130) to give the hinged fabric section 110 a more fashionable, finished look and to add a layer of concealment over the ferromagnetic disks 160 so that the outlines (or silhouettes) of the disks 160 are not visible to the wearer even after many wearings and washings of the item of apparel.

The base fabric 105 includes the ferromagnetic counterparts of the ferromagnetic disks 160, strategically placed to hold the free end 130 of the hinged fabric section 110 in place against the base fabric 105 in multiple alternative positions. In particular, one or more ferromagnetic elements 180 (e.g., strip(s), bead(s), or disk(s)) affixed to the base fabric 105 in one region attract the ferromagnetic disks 160 of the hinged fabric section 110 to that region and hold the hinged fabric section 110 in one position (e.g., a “flap down” position on an item of apparel such as the shirt shown in FIGS. 1 and 2). Likewise, one or more ferromagnetic elements 190 (e.g., strip(s), bead(s), or disk(s)) affixed to the base fabric 105 in another region attract the disks 160 to that region and hold the hinged fabric section 110 in another position (e.g., a “flap up” position).

One technique for affixing the ferromagnetic elements 180, 190 to the base fabric 105 involves the placement of strips or swaths 200, 210 of fusible-web fabric on either side of the ferromagnetic elements 180, 190 and then fusing the fusible-web swaths 200, 210 to the base fabric 105 with the ferromagnetic elements 180, 190 sandwiched between them. Where the item of apparel is an article of clothing, such as a shirt, placing a soft, supple layer of cloth lining 220 over the fusible-web swaths 200, 210 provides added comfort for the wearer and protects the wearer's skin from contact with the fusible web fabric.

The ferromagnetic disks 160 and ferromagnetic elements 180, 190 are most effective when formed from a highly magnetic material, one of sufficient magnetic force that the ferromagnetic disks 160 and elements 180, 190 can be of extremely small size and still hold the hinged fabric section 110 securely in place, no matter how many wearings and washings the apparel item undergoes over time. An ideal size for the ferromagnetic disks is on the order of ¾ inch (19 mm) in diameter (for a circular shape) or width (for a non-circular shape) and 1/64 inch (0.4 mm) in thickness so that the presence of the disks is almost imperceptible to the wearer within the layers of fabric that surround them. Neodymium magnets are particularly well-suited for this purpose.

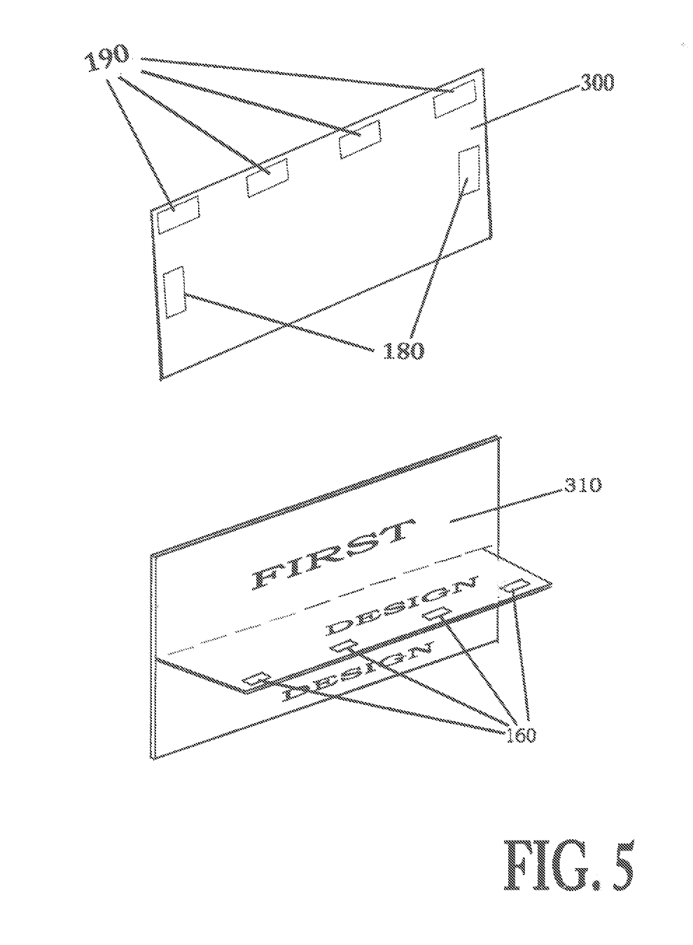

FIG. 5 shows an alternative design for the apparel graphic-changing system and further illustrates how the ferromagnetic disks 160 and elements 180, 190 can be located within the system. In this particular embodiment, the graphic-changing system is a stand-alone accessory for mounting to an item of apparel, such as a shirt. The system includes a backing layer 300 that serves the same functions as the base fabric 105 of FIGS. 1-4. The ferromagnetic elements 180, 190 are affixed to or embedded within the backing layer. The system also includes a graphics layer 310 bearing the alternative graphic designs and the hinged fabric section that allows the wearer to select among the alternative designs. The ferromagnetic disks 160 are embedded within the graphics layer 310 just as they are in the design of FIGS. 1-4. The ferromagnetic disks 160 and elements 180, 190 are arranged in patterns selected by the fabricator of the graphic-changing system in accordance with the types of fabrics being used and the types of applications and apparel in which they're being used. In the particular embodiment shown here, the backing layer 300 includes four ferromagnetic elements 190 at the “flap up” position and two ferromagnetic elements 180 at the “flap down” position (since gravity helps keep the hinged section of fabric in place in the flap-down position, fewer ferromagnetic elements are needed in this position than in the flap-up position). The graphics layer 310 in turn includes four ferromagnetic disks 160 with positions corresponding to those of the four ferromagnetic elements 190 in the flap-up position.

The embodiments of the invention described above are exemplary in nature. A wide variety of other embodiments are within the scope of the following claims.

What is claimed is:

1. An article of apparel comprising:
a base fabric bearing one or more graphical designs;
a hinged fabric section comprising:
a hinged edge attached to the base fabric,
an opposing edge free to pivot about the hinged edge; and
magnetic fasteners affixed to both the base fabric and the hinged fabric section and positioned to secure the opposing edge of the hinged fabric section to the base fabric in each of at least two orientations, where at least one of the orientations causes the hinged fabric section to hide at least a portion of the graphical design on the base fabric.

2. The article of claim 1, where at least two magnetic fasteners are positioned near the opposing edge of the hinged fabric section, at least two magnetic fasteners are positioned on the base fabric in a manner to couple with the magnetic fasteners of the hinged fabric section when the hinged fabric section is placed at one orientation, and at least two more magnetic fasteners are positioned on the base fabric in a manner to couple with the magnetic fasteners of the hinged fabric section when the hinged fabric section is placed at another orientation.

3. The article of claim 1, where at least one of the magnetic fasteners includes a magnet comprising neodymium.

4. The article of claim 1, where each of the magnetic fasteners affixed to the hinged fabric section have a diameter or width of approximately ¾ inch and a thickness of approximately 1/64 inch.

5. The article of claim 1, where the hinged fabric section comprises:
a single piece of fabric folded into halves and attached to the base fabric along the fold; and
one or more pieces of interfacing material positioned between the halves to fuse the halves together.

6. The article of claim 5, where one or more of the magnetic fasteners are positioned between the interfacing material and one of the halves of fabric and thereby embedded within the hinged fabric section.

7. The article of claim 1, where the hinged fabric section also bears a graphical design, and where at least one of the orientations causes the hinged fabric section to expose at least a portion of its graphical design.

8. The article of claim 1, where the hinged fabric section, when secured at least one of the orientations, operates in conjunction with the base fabric to display a unified graphical design.

9. The article of claim 8, where the hinged fabric section, when secured in another of the orientations, operates in conjunction with the base fabric to display an alternative unified graphical design.

10. The article of claim 1, where the base fabric comprises an article of clothing.

11. An article of apparel comprising:
an article of clothing;
at least two graphic design elements appearing on the article of clothing;
a flap of fabric affixed to the article of clothing along one edge of the flap of fabric, creating a hinge that separates the two or more graphic design elements on the article of clothing;
magnetic fasteners affixed to the flap of fabric and the article of clothing and positioned to fasten the flap of fabric to the article of clothing in each of two orientations, where the flap of fabric is positioned such that, when fastened in each of the orientations, the flap of fabric hides at least one of the graphic designs on the article of clothing.
